(19) United States
(12) Patent Application Publication
(10) Pub. No.: US 2026/0051523 A1
(43) Pub. Date: Feb. 19, 2026

(54) METHOD FOR RECYCLING AQUEOUS ELECTROLYTE BASED ON QUINONE COMPOUNDS OF A REDOX FLOW BATTERY

(71) Applicant: KEMIWATT, RENNES (FR)

(72) Inventors: Mathilde CAZOT, LYON (FR); Thibault GODET-BAR, THORIGNE-FOUILLARD (FR); Solène GUIHENEUF, NOYAL SUR VILAINE (FR); Victor ABERKANE, CHARTRES DE BRETAGNE (FR)

(21) Appl. No.: 19/101,120

(22) PCT Filed: Aug. 7, 2023
(86) PCT No.: PCT/EP2023/071867

§ 371 Date: Feb. 4, 2025

(30) Foreign Application Priority Data
Aug. 8, 2022 (FR) FR2208175

(51) Int. Cl. H01M 8/06; H01M 8/04186; H01M 8/18

(52) U.S. Cl. CPC H01M 8/0693; H01M 8/04186; H01M 8/188

(57) ABSTRACT

The present invention relates to a method for recycling an aqueous electrolyte of a redox flow battery to be recycled, the aqueous electrolyte comprising at least one electroactive compound and an aqueous solvent, the electroactive compound being at least an oxidized or reduced form of a redox couple, the oxidized form of which is a compound comprising a quinone unit, for example a benzoquinone unit, naphthoquinone unit or anthraquinone unit, preferably an anthraquinone unit, characterized in that it comprises a step (300) of precipitating the electroactive compound.

The present disclosure relates to a method for recycling an aqueous electrolyte of a redox flow battery.

### PRIOR ART

A Redox Flow Battery is a system using liquids (called electrolytes) to store energy. Redox flow batteries store electricity and generate electricity via reduction-oxidation (redox) reaction. They generally have two compartments separated by an ion exchange membrane, in which current collectors (electrodes) are generally immersed.

One of the problems with current battery storage technologies is generally their use of ores and metals having a huge impact on the environment. In addition, the complex design and use of composite materials prevents easy, economical, and efficient recycling of critical materials. Although they claim to solve the environmental impact of energy production via the storing of renewable energy (and hence a reduction in CO₂ emissions per kWh of electricity produced), the lifecycle assessment of these technologies gives very moderate sustainability. They generate resource depletion and much pollution owing to the waste represented by end-of-life batteries.

For existing technologies, recycling methods have been published in the literature e.g.:
Li-ion battery (EP1269554B1): method for recycling and separating critical materials. Said method is complex and costly to implement.
Lead-acid battery (CA2986001A1): closed loop electrochemical process to recover lead for reuse;
Vanadium redox flow battery: recycling methods have already been proposed by mixing the two electrolytes, to be operated continuously during cycling to counter cross-over of vanadium ions through the membrane (Zhang, Y., Liu, L., Xi, J., Wu, Z., & Qiu, X. (2017). The benefits and limitations of electrolyte mixing in vanadium flow batteries. Applied Energy, 204, 373-381).
Zn—Br redox flow battery: bromine neutralization recovery process (CN103236570B).

At the current time, there are no recycling solutions for redox flow batteries using redox couples based on organic or organometallic compounds, in particular organic compounds, solubilised in an aqueous medium.

KEMIWATT employs organic and organometallic electrolytes dissolved in an aqueous medium to limit the impact of this technology on the environment and depletion of resources (use of critical metals/rare earths). To date, there does not exist any solution for the recycling of such batteries.

### OBJECTIVES OF THE INVENTION

The present invention sets out to solve the technical problem of providing a method for recycling redox flow batteries which use redox couples based on organic and/or organometallic compounds in an aqueous solution.

One particular objective of the present invention is to solve the technical problem of providing a method for recycling aqueous electrolytes for redox flow batteries.

One particular objective of the present invention is to solve the technical problem of providing an easy method for processing aqueous electrolytes of spent redox flow batteries to isolate the electroactive compound(s), purify the latter and in particular make use thereof as raw material for new electrolytes.

In particular, the present invention sets out to solve the aforementioned technical problems by limiting the impact on the environment and depletion of natural resources, or by limiting the quantity of organic and/or organometallic compounds used in electrolytes, in particular in the negolyte. Finally, the present invention sets out to solve the technical problem of reducing the production costs of redox flow batteries.

### DETAILED DESCRIPTION OF THE INVENTION

The present invention allows the solving of one and preferably all the technical problems raised herein.

To reinforce the eco-compatibility and economic competitivity of redox flow batteries using aqueous electrolytes comprising organic and/or organometallic compounds, the inventors have discovered and developed a method and system for recycling the electroactive compounds of electrolytes, in particular for reuse thereof in new redox flow batteries and thereby set up a circular economy around said redox flow batteries.

Advantageously, recycling according to the present invention comprises isolating of the electroactive compound(s) contained in the electrolyte of spent batteries for subsequent upcycling thereof either directly for use in another application, or preferably by reintroducing the same in new redox flow batteries in the form of a fresh electrolyte. Redox flow batteries can advantageously be recycled once they have lost at least 20% of their initial capacity.

Therefore, with the present invention it is possible to limit the quantity of newly introduced material for the production of redox flow batteries and/or to limit the consumption of natural or synthetic raw materials.

The present invention therefore concerns a method for recycling an aqueous electrolyte of a redox flow battery to be recycled, the aqueous electrolyte comprising at least one electroactive compound and an aqueous solvent, the electroactive compound being at least an oxidized or reduced form of a redox couple of which the oxidized form is a compound comprising a quinone repeat unit, e.g. benzoquinone repeat unit, naphthoquinone repeat unit or anthraquinone repeat unit, preferably an anthraquinone repeat unit, characterized in that it comprises a precipitation step of the electroactive compound.

By electroactive compound, it is meant an organic or organometallic compound belonging to a redox couple, and indifferently designates either the oxidant (oxidized form) of the redox couple, or the reductant (reduced form) of the redox couple, or the mixture of the oxidant and reductant of the redox couple.

By aqueous electrolyte, it is meant the aqueous solutions comprising the electroactive compound(s) and placed in the positive and negative compartments of a redox flow battery.

By posolyte, it is designated the electrolyte in the positive compartment of the redox flow battery, and by negolyte the electrolyte in the negative compartment of the redox flow battery.

Preferably, the aqueous electrolyte recycled with the method of the invention is a negolyte.

Preferably, the method is characterized in that it successively comprises:
a collecting step of an aqueous electrolyte of a redox flow battery comprising at least one electroactive compound;
a precipitation step of the electroactive compound, whereby a suspension is obtained;
a separation step of the suspension, whereby a solid residue and an effluent are obtained; and
optionally, a rinsing step with water of the solid residue obtained after the separation step, whereby a rinsed solid residue is obtained.

The rinsing step with water may comprise trituration of the solid residue, and/or a second separation step to obtain a rinsed solid residue and a second effluent. The second separation step can be conducted at the same time as the rinsing and/or trituration of the solid residue.

The method may also optionally comprise a drying step, which may be partial, of the solid residue or rinsed solid residue.

The steps of the method can be implemented using any technique known to those skilled in the art.

The collecting step is preferably carried out by pumping the electrolyte(s) from the redox flow battery to be recycled towards a container, preferably directly at the site of use of the battery. In one embodiment, the collecting step additionally comprises a transferring step of the electrolyte(s) from the container towards a reactor.

The collecting step is preferably performed after a step to fully discharge the redox flow battery. In other words, the electrolyte collected at the collecting step is preferably a negolyte of which the electroactive compound is in the oxidized form thereof and/or a posolyte of which the electroactive molecule is in the reduced form thereof.

The aqueous electrolyte collected from the redox flow battery is a spent aqueous electrolyte since it has undergone at least one charging and/or discharging cycle. Preferably, the spent aqueous electrolyte is collected at the end of the cycle lifetime of the battery.

The separation step is preferably performed via filtration e.g. using a decanter centrifuge.

The solid residue obtained after the separation step comprises the precipitated electroactive compound(s).

The water rinsing and water trituration step provides improvement in the purity of the solid residue, and in particular allows removal of the precipitating agent used if it is scarcely volatile. This step is particularly suitable for recycling a negolyte.

The drying step is not compulsory, in particular if the method comprises a rinsing step with water, since the solid residue can be formulated even if it contains residual rinsing water.

The method of the invention is therefore preferably devoid of a drying step of the solid residue whether or not rinsed.

The non-inclusion of a drying step, or the reduced time and/or temperature of a partial drying step, allow minimizing of the energy costs of the method.

The drying step, if included, can be performed by heating the solid residue and/or placing this residue under reduced pressure.

Preferably, the method of the invention is characterized in that the precipitation step comprises the addition of an anti-solvent of the electroactive compound and/or the addition of an acid or base, and/or the addition of a salt to the aqueous electrolyte.

Preferably, the addition step of an anti-solvent is carried out in a reactor vessel under agitation.

By anti-solvent, it is meant an organic solvent in which the electroactive compound is less soluble than in water.

Preferably, the anti-solvent is chosen for the ability thereof to lower the solubility of the electroactive compound in the initial aqueous medium, and is preferably chosen from among solvents in which the electroactive compound is 5 times less soluble than in water, more preferably 10 times less soluble, advantageously 100 times less soluble. In other words, the ratio between the solubility of the electroactive compound in water and the solubility of the electroactive compound in the anti-solvent is preferably higher than or equal to 5, more preferably higher than or equal to 10, advantageously higher than or equal to 100. The solubility of the electroactive compound in water or anti-solvent is the maximum concentration, in g/mol at 25° C., at which the electroactive compound is able to dissolve in water or the anti-solvent respectively, forming a homogenous mixture i.e. without the formation of a precipitate.

Preferably, the anti-solvent is an organic solvent, more preferably chosen from the group of water-miscible aprotic and protic polar solvents, more preferably from among alcohols preferably aliphatic alcohols, advantageously saturated aliphatic alcohols such as methanol, ethanol, or 1-propanol and iso-propanol, and organic solvents comprising a nitrile function such as acetonitrile, or a ketone function such as acetone, or any of the mixtures thereof. The use of a mixture of at least two anti-solvents increases the amount of precipitated electroactive compound.

In the invention, an acid is an acid in the meaning of a Bronsted acid i.e. a chemical species able to donate a proton H⁺. Preferably, the acid is characterized by a pKa strictly lower than 7.

Preferably, the acid is a strong acid or a weak acid. A strong acid is an acid which fully reacts on water. A strong acid has a pKa lower than 0. The strong acid can be chosen from the group formed by sulfuric acid, hydrochloric acid, nitric acid, hydroiodic acid, hydrobromic acid, perchloric acid, permanganic acid, manganic acid, chloric acid, phosphoric acid or any of the mixtures thereof. The weak acid may comprise at least one carboxylic acid function such as formic acid, acetic acid, benzoic acid, citric acid, lactic acid, oxalic acid or maleic acid. Preferably, the acid is a strong acid. The use of a strong acid allows an increase in the amount of precipitated electroactive compound. More preferably, the acid is sulfuric acid or acetic acid, advantageously sulfuric acid.

Preferably, the quantity of acid added to the aqueous electrolyte corresponds to the quantity of acid needed to obtain a pH lower than or equal to 10, preferably lower than or equal to 8, more preferably lower than or equal to 7 and further preferably lower than or equal to 6. Still further preferably the quantity of acid added to the aqueous electrolyte corresponds to the quantity of acid needed to obtain a pH lower than or equal to 10 and higher than or equal to 1, more preferably lower than or equal to 8 and higher than or equal to 2, further preferably lower than or equal to 6 and higher than or equal to 3.

Preferably, the acid is added under agitation.

In the invention, a base is a base in the meaning of a Bronsted base i.e. a chemical species able to accept a proton H⁺. Preferably, the base is characterized by a pKa strictly higher than 7.

Preferably, the base is an inorganic base. The base can be chosen from the group formed by alkaline hydroxides such as NaOH or KOH, and alkaline carbonates such as Na₂CO₃ or K₂CO₃.

Preferably, the quantity of base added to the aqueous electrolyte corresponds to the quantity of base needed to obtain a pH higher than or equal to 7, preferably higher than or equal to 8, more preferably higher than or equal to 10. Further preferably, the quantity of base added to the aqueous electrolyte corresponds to the quantity of base needed to obtain a pH lower than or equal to 14 and higher than or equal to 7, more preferably lower than or equal to 13 and higher than or equal 10.

Preferably, the salt is an inorganic salt, preferably KCl or NaCl, or an organic salt preferably sodium acetate or ammonium carbonate.

Preferably, the inorganic salt is chosen from among inorganic salts having a cation corresponding to the cation or to one of the cations contained in the aqueous electrolyte to be recycled.

The addition of an anti-solvent of the electroactive compound, the addition of an acid or base and the addition of a salt to the aqueous electrolyte can be combined two-by-two or can all be added together to optimize precipitation of the electroactive compound, as a function of the solubility thereof.

Preferably, the precipitation step comprises the addition of an acid to the aqueous electrolyte, preferably until a pH lower than or equal to 10 is obtained, preferably lower than or equal to 8, more preferably lower than or equal to 7, further preferably lower than or equal to 6, or the addition of a base preferably until a pH higher than or equal to 7 is obtained, preferably higher than or equal to 8, more preferably higher than or equal to 10.

In particular, it has been found that precipitation is instantaneous for quinones comprising one or more substituents of type —R¹ and/or -A-R¹ and/or —O-A-R¹, with R¹=OH or COOH, more preferably with R¹ representing COOH.

The choice of use of an acid or base is therefore dependent on the initial pH of the electrolyte to be recycled, with a view to reaching the above pH values at which the electroactive compound is precipitated.

In one embodiment, the precipitation step comprises the addition of a strong acid, preferably sulfuric acid, the volume of added strong acid representing between 0.1% and 40% of the volume of the aqueous electrolyte to be processed, preferably between 0.1% and 15%, more preferably between 0.1% and 12%, depending on the initial pH of the solution and the composition thereof.

In another embodiment, the precipitation step comprises the addition of a weak acid, preferably acetic acid, the volume of added weak acid representing between 0.1% and 60% of the volume of the aqueous electrolyte to be processed, preferably between 0.1% and 55%, more preferably between 0.1% and 50%.

In a still further embodiment, the precipitation step comprises the addition of a base in the form of an aqueous solution of an alkaline hydroxide in which the concentration of alkaline hydroxide is between 1 and 25 moles per litre, preferably between 4 and 20 moles per litre, more preferably 4 and 8 moles per litre, the volume of added base representing between 0.1% and 40% of the volume of the aqueous electrolyte to be processed, preferably between 0.1% and 30%, more preferably between 0.1% and 22%, depending on the initial pH of the solution and the composition thereof.

The precipitation of the electroactive compounds does not specifically depend upon the concentration of electroactive compounds in the electrolyte. It is chiefly the pH to be reached for precipitation of the electroactive compounds which acts as guide for the quantity of acid to be added at the precipitation step.

Preferably, at the precipitation step, the aqueous electrolyte is at a temperature of between 5° C. and 40° C., preferably between 5° C. and 20° C.

Preferably, the electroactive compound of the aqueous electrolyte is at least one form of a redox couple of which the oxidized form is a compound comprising an anthraquinone repeat unit. Preferably, the aqueous electrolyte is a negolyte.

A compound comprising an anthraquinone repeat unit according to the invention is preferably a compound of formula (F):

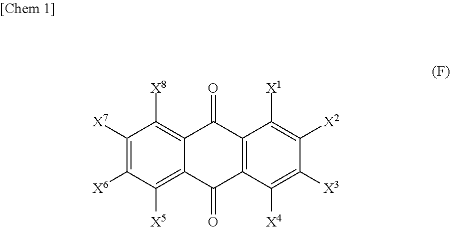

where X¹, X², X³, X⁴, X⁵, X⁶, X⁷ and X⁸ are each independently chosen from the group formed by a hydrogen atom, an OH group, COOH group, SO₃H group, -A-COOH group, —O-A-COOH group, -A-SO₃H group, —O-A-SO₃H group, and a saturated or unsaturated, linear, cyclic, or branched hydrocarbon group having 1 to 10 carbon atoms
A being a saturated or unsaturated, linear, cyclic, or branched hydrocarbon group having 1 to 10 carbon atoms,
and/or a salt thereof, in particular a sodium or potassium salt.

Preferably, at least one among X¹, X², X³, X⁴, X⁵, X⁶, X⁷ and X⁸ comprises an OH, SO₃H, COOH function, and/or any of the salts thereof, in particular a sodium or potassium salt.

Preferably, X¹, X², X³, X⁴, X⁵, X⁶, X⁷ and X⁸ are each independently chosen from the group formed by a hydrogen atom, an OH group, COOH group, SO₃H group, -A-COOH group, —O-A-COOH group, -A-SO₃H group and —O-A-SO₃H group.

Preferably, five or six groups among X¹, X², X³, X⁴, X⁵, X⁶, X⁷ and X⁸ are hydrogens. Particular mention can be made of the compounds described in PCT application WO2021123334.

This patent application particularly describes compounds in oxidized form of formula (I):

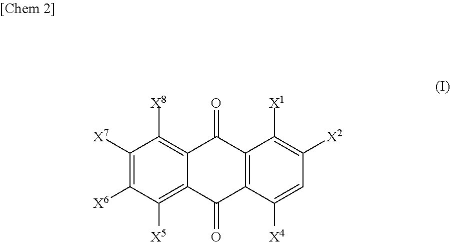

and/or a salt thereof, in particular a sodium or potassium salt.

In the structure of formula (I), X¹, X², X⁴, X⁵, X⁶, X⁷ and X⁸ are each independently chosen from among a hydrogen atom, a saturated or unsaturated, linear, cyclic or branched C1-C10 hydrocarbon group, optionally substituted, an OH group or —O-A-R¹ group,
A is a saturated or unsaturated, linear cyclic, or branched C1-C10 hydrocarbon group, optionally substituted;
R¹ is COOH or SO₃H; and
in the structure of formula (I), one and only one from among X¹, X², X⁴, X⁵, X⁶, X⁷ and X⁸ represents OH, and one and only one from among X¹, X², X⁴, X⁵, X⁶, X⁷ and X⁸ represents-O-A-R¹.

In another embodiment, the electroactive compound of the aqueous electrolyte is at least one form of a redox couple of which the oxidized form is a compound comprising a naphthoquinone repeat unit.

A molecule based on a naphthoquinone repeat unit according to the invention is preferably a compound of formula (G):

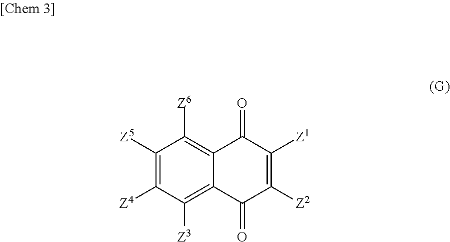

where Z¹, Z², Z³, Z⁴, Z⁵ and Z⁶ are each independently chosen from the group formed by a hydrogen atom, an OH group, COOH group, SO₃H group, -A-COOH group, —O-A-COOH group, -A-SO₃H group, —O-A-SO₃H group, and a saturated or unsaturated, linear, cyclic or branched hydrocarbon group having 1 to 10 carbon atoms,
A being a saturated or unsaturated, linear, cyclic, or branched hydrocarbon group having 1 to 10 carbon atoms, and/or a salt thereof, in particular a sodium or potassium salt.

Preferably, at least one among Z¹, Z², Z³, Z⁴, Z⁵ and Z⁶ comprises an OH, SO₃H, COOH function, and/or any of the salts thereof in particular a sodium or potassium salt.

Preferably, Z¹, Z², Z³, Z⁴, Z⁵ and Z⁶ are each independently chosen from the group formed by a hydrogen atom, an OH group, COOH group, SO₃H group, -A-COOH group, —O-A-COOH group, -A-SO₃H group and —O-A-SO₃H group.

Preferably, four or five groups among Z¹, Z², Z³, Z⁴, Z⁵ and Z⁶ are hydrogens. Preferably, Z²=Z³=Z⁴=Z⁵=Z⁶=H.

In another embodiment, the electroactive compound of the aqueous electrolyte is at least one form of a redox couple of which the oxidized form is a compound comprising a benzoquinone repeat unit.

A molecule based on a benzoquinone repeat unit according to the invention is preferably a compound of formula (H):

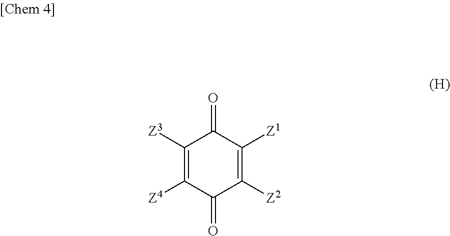

or a compound of formula (K):

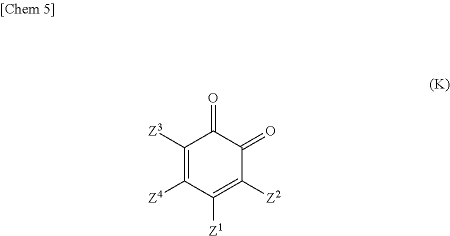

where Z¹, Z², Z³ and Z⁴ are each independently chosen from the group formed by a hydrogen atom, an OH group, COOH group, SO₃H group, -A-COOH group, —O-A-COOH group, -A-SO₃H group, —O-A-SO₃H group, and a saturated or unsaturated, linear, cyclic, or branched hydrocarbon group having 1 to 10 carbon atoms,
A being a saturated or unsaturated, linear, cyclic, or branched hydrocarbon group having 1 to 10 carbon atoms,
and/or a salt thereof, in particular a sodium or potassium salt.

Preferably, at least one among Z¹, Z², Z³ and Z⁴ comprises an OH, SO₃H, COOH function, and/or any of the salts thereof, in particular a sodium or potassium salt, in particular a function SO₃H.

Preferably, Z¹, Z², Z³ and Z⁴ are each independently chosen from the group formed by a hydrogen atom, an OH group, a methyl or ethyl group, COOH group, SO₃H group, -A-COOH group, —O-A-COOH group, -A-SO₃H group, and —O-A-SO₃H group.

More preferably, at least two among Z¹, Z², Z³ and Z⁴ differ from a hydrogen atom. Preferably, two or three among Z¹, Z², Z³ and Z⁴ differ from a hydrogen atom.

In one embodiment, in the compound of formula (H), Z⁴=H. Preferably, Z⁴=H and Z¹, Z² and Z³ are each independently chosen from the group formed by a methyl or ethyl group, COOH group, and SO₃H group. Advantageously, Z⁴=H, Z¹=Z³=Me, and Z²=SO₃H or COOH, preferably SO₃H.

In one embodiment, in the compound of formula (J), Z¹=Z³=H. Preferably, Z¹=Z³=H, and Z² and Z⁴ are each independently chosen from the group formed by a methyl or ethyl group, COOH group and SO₃H group. Advantageously, Z¹=Z³=H, and Z²⁼⁷⁴=SO₃H or COOH, preferably SO₃H.

The oxidized form of the redox couple included in the electrolyte can be chosen in particular from among the following compounds:
AQDS(2,7): disodium 9,10-anthraquinone-2,7-disulfonate
AQDS(1,5): disodium 9,10-anthraquinone-1,5-disulfonate
AQDS(1,8): dipotassium 9,10-anthraquinone-1,8-disulfonate
AQDS(2,6): 9,10-anthraquinone-2,6-disulfonic acid
AQS(2): sodium 9,10-anthraquinone-2-sulfonate
AQS(2)DH (Alizarin red s): sodium 3,4-dihydroxy-9,10-anthraquinone-2-sulfonate
AQS(2)NBr: sodium 1-amino-4-bromo-9,10-anthraquinone-2-sulfonate
NQ(1,4)HB (Lapachol): 2-hydroxy-3-(3-methyl-2-butenyl)-1,4-naphthoquinone
NQ(1,4)H: 2-hydroxy-1,4-naphthoquinone
NQ(1,4)DHCl: 2,3-dichloro-5,8-dihydroxy-1,4-naphthoquinone
AQDH(2,6) (Anthraflavic acid): 2,6-dihydroxy-9,10-anthraquinone
AQDH(1,8) (Chrysazin): 1,8-dihydroxy-9,10-anthraquinone
AQDH(1,5) (Anthrarufin): 1,5-dihydroxy-9,10-anthraquinone
AQTH(1,2) (Quinalizarin): 1,2,5,8-tetrahydroxy-9,10-anthraquinone
AQDH(1,2) (Alizarin): 1,2-dihydroxy-9,10-anthraquinone
AQDH(1,4) (Leucoquinizarin): 2,3-dihydro-9,10-dihydroxy-1,4-anthraquinone
AQDH(1,8) MH (Aloemodin): 1,8-dihydroxy-3-(hydroxymethyl)-9,10-anthraquinone
ARSNa: 1,2-dihydroxy-3-(sodium sulfonate)-9,10-anthraquinone
ARSK: 1,2-dihydroxy-3-(potassium sulfonate)-9,10-anthraquinone
AQTrHM (Emodin): 1,3,8-trihydroxy-6-methylanthracene-9,10-dione
AQTH(1,4): 1,4,5,8-tetrahydroxy-9,10-anthraquinone
AQDH(1,8) CA (Rhein): 4,5-dihydroxy-9,10-anthraquinone-2-carboxylic acid
HQ(1,4)S: potassium 2,5-dihydroxybenzenesulfonate
HQ(1,2): Ortho hydroquinone
HQ(1,4): Para hydroquinone
HQ(1,2)DS (Tiron): 4,5-dihydroxy-1,3-benzenedisulfonate disodium monohydrate
HQ(1,4)DH: 2,5-dihydroxy-1,4-benzoquinone
BQ(1,4)DHDCl (Chloranilic acid): 2,5-dichloro-3,6-1,4-benzoquinone
HQ(1,4)TCl: Tetrachloro hydroquinone
BQ(1,4)TH: Tetrahydroxy-1,4-benzoquinone
HQ(1,4)TF: 1,2,4,5-tetrafluoro-3,6-dihydroxybenzene.
(M3CH): compound of formula (F) with X¹=OH, X⁴=—O—(CH₂)₃—COOH and X²=X³=X⁵=X⁶=X⁷=X⁸=H.
DBEAQ: compound of formula (F) with X²=X⁶=—O—(CH₂)₃—COOH and X¹=X³=X⁴=X⁵=X⁷=X⁸=H.
BQDS: 1,2-dihydrobenzoquinone-3,5-disulfonic acid (compound of formula (K) with Z¹=Z³=H, and Z²=Z⁴=SO₃H).
DHDMBS: 3,6-dihydroxy-2,4-dimethylbenzene sulfonic acid (compound of formula H with Z⁴=H, Z¹=Z³=Me, and Z²=SO₃H)

In one embodiment, the method of the invention is characterized in that it additionally comprises a formulation step of the solid residue, comprising the dissolution of the solid residue in an aqueous medium to obtain a recycled electrolyte. The solid residue is optionally rinsed and/or dried.

This formulation step may further comprise the addition of other constituents to the recycled electrolyte e.g. additives.

The choice of other constituents is dependent on the desired performance of the recycled electrolyte.

The method of the invention may additionally comprise a step to input the recycled electrolyte obtained after the formulation step (700) into the negative or positive compartment of a redox flow battery.

Preferably, the electrolyte is a negolyte, and the method of the invention comprises a chemical oxidation step between the collecting step and precipitation step, comprising the contacting of the negolyte with an oxidant able to oxidize the reduced form of the redox couple.

This step is preferably implemented when the negolyte has been collected from a redox flow battery which has not been fully discharged before the collecting step.

Therefore, preferably, the electroactive compound to be precipitated is the oxidant of the redox couple contained in the negolyte.

By oxidant able to oxidize the reductant of the redox couple, it is meant any compound belonging to a redox couple differing from the redox couple in the negolyte and having a standard redox potential strictly higher than the standard redox potential of the redox couple contained in the negolyte.

Preferably, the contacting step of the negolyte with a reductant able to reduce the oxidant of the redox couple is the contacting of the negolyte with air, the dioxygen in air spontaneously oxidizing the reductant of the redox couple in the negolyte.

Alternatively, the oxidant is chosen from the group formed by metal oxides e.g. silver or chromium oxide, inorganic oxidants e.g. ozone, diiodine, oxone (KHSOs), organic oxidants chosen from among:
peracids e.g. meta-chloroperoxybenzoic acid (mCPBA) or magnesium monoperoxyphthalate (MMPP);
peroxides e.g. tert-butyl hydroperoxide (tBuOOH);
N-oxides e.g. N-methylmorpholine N-oxide (NMO) or 2,2,6,6-tetramethylpiperidin-1-yl)oxy (TEMPO);
pyridine-chromium couples e.g. pyridinium dichromate (PDC) or pyridinium chlorochromate (PCC);
2-iodoxybenzoic acid (IBX) or the Dess-Martin periodinane derivative; and
2,3-dichloro-5,6-dicyanobenzoquinone (DDQ).

Alternatively, any oxidized form of the electroactive compound of a posolyte can also be used as oxidant for the reductant of the negolyte.

In another embodiment, the electrolyte is a posolyte and the method of the invention comprises a chemical reduction step between the collecting step (200) and the precipitation step (300), comprising the contacting of the posolyte with a reductant able to reduce the oxidized form of the redox couple.

This step is preferably implemented when the posolyte has been collected from a redox flow battery which has not been fully discharged before the collecting step.

Therefore, preferably, the electroactive molecule to be precipitated is the reductant of the redox couple contained in the posolyte.

By reductant able to reduce the oxidized form of the redox couple, it is meant any compound belonging to a redox couple differing from the redox couple contained in the posolyte and having a standard redox potential lower than the standard redox potential of the redox couple contained in the posolyte.

Preferably, the contacting step of the posolyte with a reductant able to reduce the oxidizing agent of the redox couple comprises the addition of a reductant to the aqueous posolyte. Preferably, the addition of a reductant to the aqueous posolyte is performed by monitoring the pH which must preferably remain higher than or equal to 8.

Preferably, the reductant is chosen from the group formed by H₂O₂, Na₂SO₃, Na₂S₂O₄, Na₂S₂O₃, N₂H₄ (hydrazine), I₂ (iodine) and organic reducing agents such as ascorbic acid, citric acid, and the derivatives of glucose.

In one variant, the method of the invention additionally comprises a step to treat the effluent obtained after the separation step, to obtain a treated effluent. The treated effluent can be reused at the precipitation step.

The method of the invention may additionally comprise a step to verify the purity of the solid residue, for example by chemical and/or electrochemical analysis.

In one embodiment of the method of the invention, the aqueous electrolyte to be recycled may comprise at least one additive. In this embodiment, depending on the solubility of the additive, the additive is either recycled with the electroactive compound and in this case is included in the solid residue, or it is included in the effluent obtained on completion of the method.

By additive, it is meant any compound able to increase some physicochemical properties of the electrolyte.

The invention also concerns a system for recycling an aqueous electrolyte of a redox flow battery, comprising:
a collecting device (30) of an aqueous electrolyte (10) from a redox flow battery (20), the aqueous electrolyte (10) comprising at least one electroactive compound and an aqueous solvent, and
a precipitation device (40) of the electroactive compound via the addition of an anti-solvent of the electroactive compound and/or addition of an acid or base and/or addition of a salt, to obtain a suspension.

The collecting device preferably comprises a collector vessel for the collected aqueous electrolyte and a device capable of transferring the electrolyte from the redox flow battery towards the collector vessel. The collector vessel is in fluid communication with the negative or positive compartment of the redox flow battery to be recycled. The aqueous electrolyte collected from the redox flow battery is a spent aqueous electrolyte since it has undergone at least one charge and/or discharge cycle. Preferably, the spent aqueous electrolyte is collected at the end of the cycle lifetime of the battery.

The device of the invention may additionally comprise a first storage vessel comprising an anti-solvent of the electroactive compound of the collected aqueous electrolyte, and/or comprising an acid or base solution and/or a salt solution such as defined in the description of the method of the invention, more preferably an acid storage vessel. The first storage vessel is in fluid communication with the precipitation device.

In one embodiment, the recycling system of the invention comprises a discharging device able to oxidize the reductant of the redox couple in the negolyte, or able to reduce the oxidant of the redox couple in the posolyte. The discharging device is preferably in fluid communication with a second storage vessel comprising an oxidant able to oxidize the reductant of the redox couple, or a reductant able to reduce the oxidant of the redox couple such as defined above. The discharging device is preferably in fluid communication with the collector vessel and precipitation device.

Preferably, the recycling system of the invention additionally comprises a separation device to separate the suspension derived from the precipitation device into a solid residue and an effluent. For example, the separation device can be a decanter centrifuge.

The solid residue obtained in the separation device comprises the precipitated electroactive compound(s).

In one embodiment, the recycling system of the invention comprises a system for rinsing the solid residue, preferably rinsing with water, to obtain a rinsed solid residue.

The separation device is preferably in fluid communication with the precipitation device and the drying or formulation device.

In one embodiment of the invention, the separation device is able to dry the optionally rinsed solid residue, partially or fully. In this embodiment, the drying device is included in the separation device.

Alternatively, the system of the invention comprises a device for drying the solid residue by heating and/or by placing the optionally rinsed solid residue under reduced pressure.

In one embodiment, the system of the invention additionally comprises a device to treat the effluent derived from the separation device, to obtain a treated effluent. The treatment device is in fluid communication with the storage vessel and/or with the precipitation device.

Preferably, the recycling system of the invention additionally comprises a formulation device to formulate the solid residue in the form of a recycled electrolyte.

The system of the invention may additionally comprise a formulation vessel comprising an aqueous solution optionally comprising one or more additives such as defined above. The formulation vessel is in fluid communication with the formulation device.

On leaving the formulation device, the recycled electrolyte can be sent into the positive or negative compartment of a new redox flow battery, preferably via a fluid connection.

Preferably, the recycling system of the invention is used to implement the method of the invention.

### Advantage of the Invention

It is particularly surprising that said electroactive compounds are able to be recycled by precipitation. The recycling method of the invention is particularly easy to implement and hence particularly innovative. With this method, it is possible to obtain very good recycling yields of electroactive compounds.

Most surprisingly, the electroactive compounds recycled with the method of the invention can be reused for fresh cycling in a new redox flow battery, giving very satisfactory performance in particular in terms of capacity and/or ohmic resistance (<2 Ω·cm²) and with stability over repeated operating cycles of the redox battery, the battery remaining substantially stable over several ten or hundred cycles. Such performance is unexpected for those skilled in the art.

A further advantage of the method of the invention is that a small quantity of reagents is used (in proportion to treated volume). In addition, these reagents are easily available (and already used in numerous other applications), and also low-cost. For example, acetic acid or sulfuric acid are not a significant threat for the environment.

Additionally, precipitation is rapid and the method of the invention does not generate any pollution of the recycled electroactive compounds: purification of the solid residue solely requires a rinsing step and optionally evaporation. Advantageously, the yield of the method of the invention, and the reduced cost thereof, allow industrialization of the method and system of the invention.

Unless specifically stated otherwise, the expressions «from X to Y» and «between X and Y» designate ranges of which the limits X and Y are included.

### FIGURES

FIG. 1 is a schematic block diagram of a method of the invention.

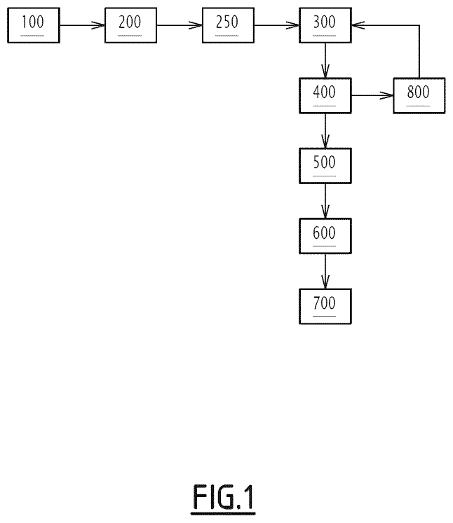

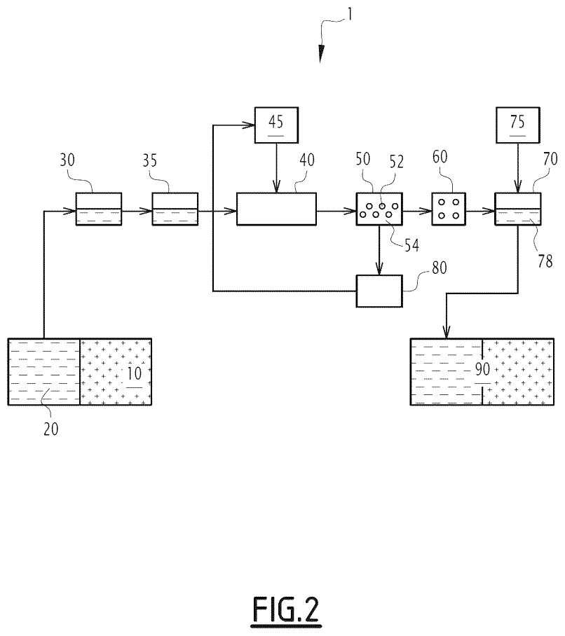

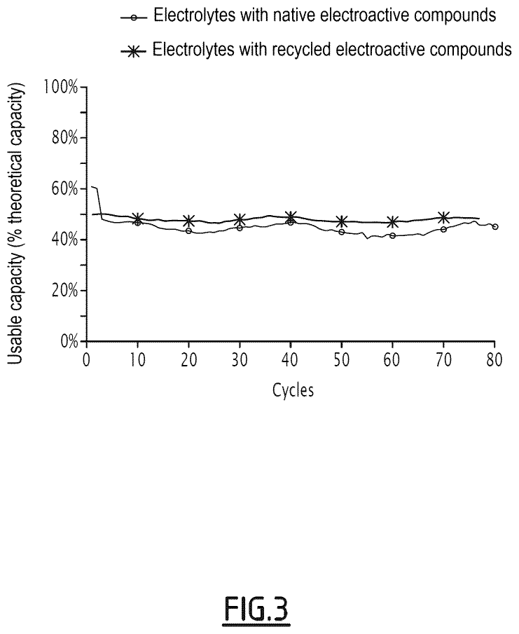

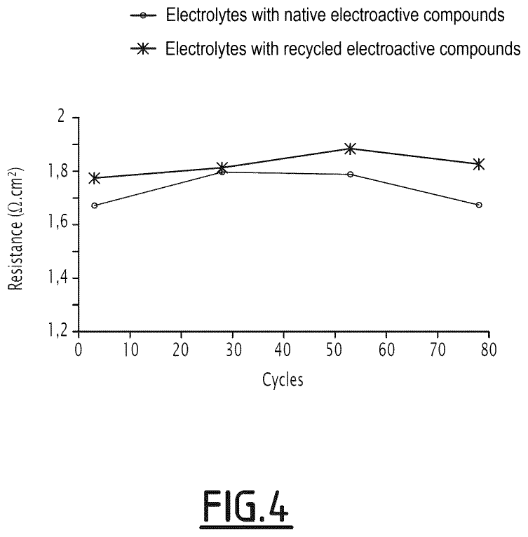

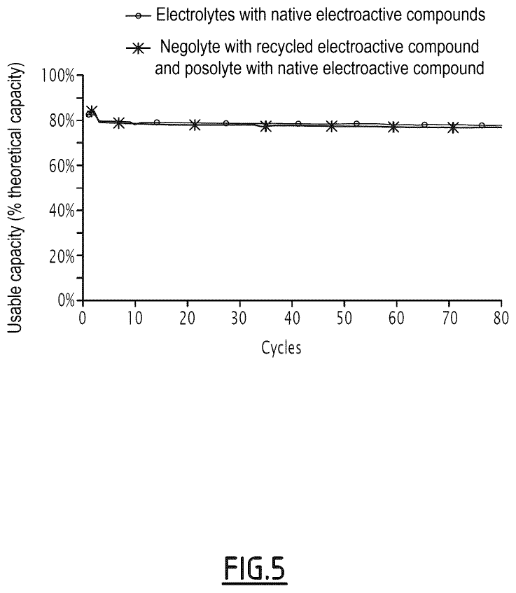

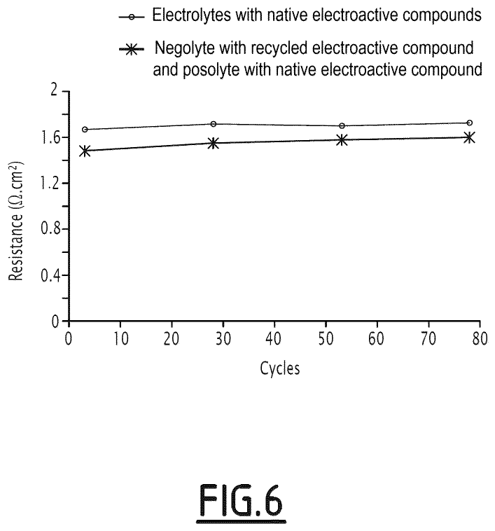

After the cycling 100 of a redox flow battery, at least one aqueous electrolyte of the redox flow battery is collected at a collecting step 200. The electroactive compound(s) contained in the aqueous electrolyte are optionally contacted with an oxidant of reductant, to be discharged at a chemical oxidation or reduction step (250). The electroactive compound(s) contained in the aqueous electrolyte are precipitated at a precipitation step 300, preferably via the addition of an anti-solvent of the electroactive molecule and/or the addition of an acid or base and/or the addition of a salt to the aqueous electrolyte. The suspension obtained after the precipitation step 300 is then separated into a solid residue and an effluent at a separation step 400. A solid residue comprising the electroactive compound(s), and an effluent are obtained. The solid residue can be rinsed with water and triturated at a water rinsing and water trituration step 500. The solid residue, whether or not rinsed, can optionally be dried at a drying step 600 to reduce the quantity of water and/or solvent in the solid residue. The solid residue can then be formulated at a formulation step 700, to obtain a recycled electrolyte. The recycled electrolyte can be used in a new redox flow battery alone or in a mixture with an electrolyte comprising one or more native electroactive compounds i.e. which have never been used in a charge and/or discharge cycle of a redox flow battery. In parallel, the effluent obtained after the separation step can be treated at a treatment step 800, to obtain a treated effluent able to be reused at the precipitation step 300 when the method of the invention is next implemented.

FIG. 2 schematically illustrates a recycling system 1 of the invention of an aqueous electrolyte of a redox flow battery 10. FIG. 2 illustrates the recycling of a negolyte but can be fully transposed for a posolyte.

A negolyte 20 of a redox flow battery 10 is collected in a collector vessel 30, optionally conveyed towards a discharging device 35 then conveyed towards a precipitation device 40. An acid or base and/or an anti-solvent and/or salt solution derived from a storage vessel 45 is added to the negolyte 20 in the precipitation device 40 to cause precipitation of the electroactive compound(s) of the negolyte 20. The suspension obtained is separated, preferably via filtration, in a separation device 50. A solid residue 52 comprising the electroactive compound(s) of the negolyte 20 and an effluent 54 are obtained. The effluent 54 is received in an effluent collector device 80 and can be treated and redirected towards the storage vessel 45. Optionally, the solid residue 52 is rinsed with water and triturated with water, then separated a second time to remove the wash water. Optionally, the residue 52 (whether or not rinsed) is dried or partially dried, either directly in the separation device, or after being transferred to a drying device 60. The drying device allows the residue 52 to be heated under controlled temperature and/or placed under reduced pressure, thereby reducing the amount of water and any solvents remaining in the solid residue 52. The solid residue 52 is then conveyed towards a formulation device 70. An aqueous solution optionally comprising additives is also sent into the formulation device 70 from a formulation vessel 75 to prepare a recycled negolyte 78. The recycled negolyte 78 can be sent into the negative compartment of a new redox flow battery 90.

FIG. 3 is a graph showing usable battery cycling capacity (TRL 4) (as a percentage of the theoretical capacity of the electrolytes) of a battery comprising electrolytes with native electroactive compound, and a battery comprising electrolytes with recycled electroactive compound.

FIG. 4 is a graph showing battery resistance (TRL 4) measured on a polarisation curve of a battery comprising electrolytes with native electroactive compound, and a battery comprising electrolytes with recycled electroactive compound.

FIG. 5 is a graph showing usable battery cycling capacity (TRL 4) (as a percentage of the theoretical capacity of the electrolytes) of a battery comprising electrolytes solely having native electroactive compounds, and a battery comprising a posolyte with native electroactive compound and negolyte with recycled electroactive compound. a

FIG. 6 is a graph showing battery resistance (TRL 4) measured on a polarisation curve of a battery comprising electrolytes solely having native electroactive compounds, and a battery comprising a posolyte with a native electroactive compound and a negolyte with a recycled electroactive compound.

The present invention is now described with reference to nonlimiting examples.

### EXAMPLES

### Example 1: Recycling and Battery Test of the Redox Couple Ferrocyanide/Ferricyanide (Posolyte) and Anthraquinone (M3CH) (Negolyte)

The recycling method was performed on electrolytes that had been used in a battery (>350 cycles and cycling time of 6 months). The results give both the characteristics of the recycling method and the performance of batteries comprising the recycled electrolytes.

At the end of the cycling time, the electroactive compound(s) of the ferrocyanide/ferricyanide redox couple in the posolyte (according to the final state of charge of the electrolytic solution) were first chemically reduced e.g. though the addition of H₂O₂, while monitoring pH (which must preferably remain higher than 8) and under agitation, to obtain a posolyte comprising 100% ferrocyanide.

Precipitation was then performed with the addition of 96% ethanol (in liquid form) to the posolyte under magnetic stirring; the quantity required to cause precipitation of the ferrocyanide is dependent on the temperature and concentration of the solution. The ferrocyanide concentration in the posolyte was 0.34 M. Precipitation was instantaneous and visually detectable. The addition of ethanol must be controlled since the effect would be counter-productive if a certain volume is exceeded, and the ferrocyanide would re-dissolve in the solvent mixture.

The solution was afterwards filtered (e.g. in the laboratory on (5-10 μm) filter paper), and the solid residue obtained was dried of residual traces of solvent (water+ethanol) via evaporation.

Regarding the negolyte, the electroactive compound used, in its oxidized form, was the following molecule:

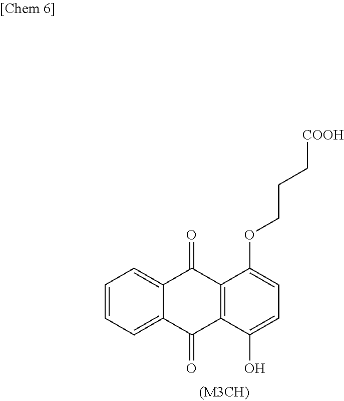 [SMILES: O=C(O)CCCOc1ccc(O)c2c1C(=O)c1ccccc1C2=O]

(concentration: 0.2 M).

The fraction of the electroactive molecule (M3CH) of the negolyte being in reduced form, it is automatically discharged (i.e. is oxidized) through the action of the dioxygen in air. Precipitation of the electroactive molecule was caused by acidification of the negolyte solution up to a pH value lower than or equal to 6. The method was tested with several types of acid (strong acid e.g. sulfuric acid, weak acid e.g. acetic acid), and led to equivalent results. The quantity of acid to be added is solely dependent on the volume of electrolyte to be processed and the initial pH thereof. It is added under agitation. As soon as the pH value is lower than or equal to 6, precipitation is instantaneous. The effluent can be filtered on a filter with large pore size since the cake obtained is very compact forming a block. The precipitate must be rinsed with water to remove traces of acid and then spread out to facilitate the drying step and to remove residual traces of solvent.

The type and quantity of solvent used for each electrolyte, and the yields and purities obtained are given in Table 1. The necessary quantities of solvent were 10 and 30% by volume respectively for the negolyte and posolyte. This addition tends to decrease for the posolyte when the concentration of electroactive compound increases. Yields are higher than 65%, with an expected improvement under an optimized industrial process. The purity of the recycled electroactive compound obtained after simple drying was estimated by quantitative proton NMR (¹H-qNMR) in the presence of an internal standard. This purity was 92 and 93% respectively, proving the easy removal of the solvent used for precipitation. In comparison, the purity of these same native electroactive compounds is about 97% for anthraquinone and 96% for the ferrocyanide salt.

Quantitative NMR: ¹H NMR spectra were recorded on a BRUKER AC 300 P spectrometer (300 MHZ). Maleic acid (Acros Organics) was used as internal standard to evaluate the purity of the compounds.

TABLE 1

| Recycling of electroactive compounds | Negolyte | Posolyte |
|---|---|---|
| Concentration of electroactive | 0.2M | 0.34M |
| compounds | | |
| Proportion of added solvent | 10% | 30% |
| (% total volume of electrolyte | (99% pure | (96% |
| to be recycled) and type of | CH₃COOH) | Ethanol) |
| solvent | | |
| Recycling yield | 65% | 72% |
| Purity of electroactive | 92% | 93% |
| compound after drying | | |
| (¹H-qNMR) | | |

FIGS. 3 and 4 give the performance levels obtained with a battery comprising electrolytes comprising native electroactive compound(s), and with a recycled battery i.e. comprising a negolyte and posolyte formulated from recycled electroactive compound(s). The initial pH of the electrolytes was 13.

The usable capacity (FIG. 3) was the same for both batteries (the difference which can be seen between the two curves lies within the reproducibility error), which surprisingly proves that recycling via precipitation of the electroactive compounds has no impact on the electrochemical activity thereof. The trend in this capacity over cycling is stable.

Battery internal resistance (FIG. 4) was also equivalent for both batteries and remained constant over cycling. This result surprisingly confirms that the solvents used for precipitation have no impact on the performance of the system.

Comparison between the two battery tests highlights the fact that the active materials of an aqueous organic redox flow battery can be recycled by precipitation and reused in a new storage system without deterioration of performance.

A negolyte comprising M3CH as electroactive compound in combination with an additive was also recycled following the above protocol. The type and quantity of solvent used, and the yields and purities obtained by quantitative NMR in the presence of an internal standard are given in Table 2.

TABLE 2

| Recycling of electroactive compounds | Negolyte |
|---|---|
| Concentration of electroactive | 0.2M |
| compounds in the negolyte | |
| Proportion of added solvent | 11% |
| (% total volume of electrolyte | (99% pure |
| to be recycled) and type of | CH₃COOH) |
| solvent | |
| Recycling yield | 72% |
| Purity of the electroactive | 88% |
| compound after drying | |
| (¹H-qNMR) | |

The results in the above table show that the presence of additives in the negolyte does not perturb the recycling method, since similar levels of recycling performance are obtained with and without additives.

FIGS. 5 and 6 give the performance obtained with a battery comprising electrolytes with native electroactive compound(s), and with a partially recycled battery i.e. comprising a native posolyte but a negolyte formulated from recycled electroactive compound(s), the negolyte initially comprising at least one additive. The initial pH of the electrolytes was 12.

The results obtained are similar to those of the fully recycled battery without additives (FIGS. 3 and 4): usable capacity (FIG. 5) and internal battery resistance (FIG. 6) are the same before and after recycling. This demonstrates that the method and system of the invention are applicable to negolytes, even in the event that they comprise additives.

### Example 2: Recycling of Other Electroactive Compounds

Electroactive compounds for negolyte differing from anthraquinone (M3CH) were efficiently recycled with the method of the invention.

Their structure, recycling conditions and performance are grouped together in the following table:

TABLE 4

| | Initial | | | | |
|---|---|---|---|---|---|
| | purity of | | | | |
| | the | | | | |
| | molecule | | | | |
| | (before | | | | |
| | use as | Formulation | | Purity of the | |
| | electroactive | of the | Conditions | electroactive | |
| | compound | negolyte | of the | compound | Re- |
| | of a | to be | precipita- | after drying | cycling |
| Electroactive compound | negolyte) | recycled | tion step | (¹H NMR) | yield |
| 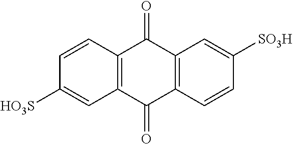 [SMILES: O=C1c2ccc(S(=O)(=O)O)cc2C(=O)c2ccc(S(=O)(=O)O)cc21] | 68% | 0.5 M 2,6- AQ-DS + 1M H₂SO₄ | 20% v/v KOH at 5 M | 82% | 21% |
| 2,6-DS-AQ | | | | | |
| 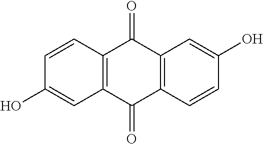 [SMILES: O=C1c2ccc(O)cc2C(=O)c2ccc(O)cc21] | 95% | 0.5 M 2,6- OH-AQ + 1 M KOH | 40% v/v AcOH at 99.5% | 89% | 74% |
| 2,6-OH-AQ | | | | | |
| 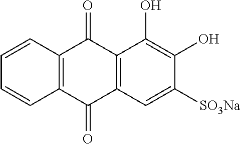 | 83% | 0.2 M ARSNa + 1.2 M KOH | 4% v/v H₂SO₄ at 99.5% | 87% | 69% |
| ARSNa | | | | | |
| 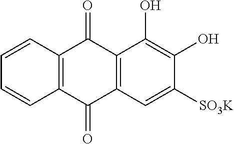 | 82% | 0.44 M ARSK + 1.7 M KOH | 40% v/v AcOH at 99.5% 4.8% v/v H₂SO₄ at 99.5% | 63% 93% | 51% 76% |
| ARSK | | | | | |
| 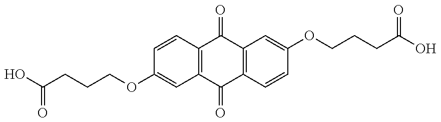 [SMILES: O=C(O)CCCOc1ccc2c(c1)C(=O)c1ccc(OCCCC(=O)O)cc1C2=O] | 98% | 0.65 M DBEAQ + 1M KOH 0.2 M DBEAQ + >1 M KOH | 38.46% v/v AcOH at 99.5% 10% v/v H₂SO₄ at 99.5% | 75% 77% | 66% 75% |
| DBEAQ | | | | | |
| 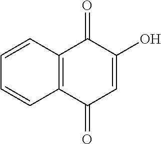 [SMILES: O=C1C=C(O)C(=O)c2ccccc21] | 98% | 0.2 M NQ(1,4)H + 1M KOH | 4.67% v/v H₂SO₄ at 99.5% | 59% | 90% |
| NQ(1,4)H | | | | | |

The molecules were either purchased or synthesized to carry out the recycling tests. They were placed in solution under conditions similar to those reported in the literature for organic flow batteries. Several tests were performed to evaluate the possibility of recycling the molecules without degrading their chemical structure. The integrity of the molecules after recycling was verified by NMR, and recycling yield was evaluated by weighing after drying then calculated with the purity obtained by quantitative NMR. The results show good recycling possibilities for most of the tested molecules; an improvement in yield was observed when a strong acid was used, allowing pKa values below those of the functional groups to be obtained and hence greater precipitation of the active species.

1. A method for recycling an aqueous electrolyte of a redox flow battery to be recycled, the aqueous electrolyte comprising at least one electroactive compound and an aqueous solvent, the electroactive compound being at least an oxidized or reduced form of a redox couple, the oxidized form of which is a compound comprising a quinone unit, that the method comprising a precipitation step of the electroactive compound.

2. The method according to claim 1, successively comprising:
a collecting step of the aqueous electrolyte of the redox flow battery comprising the at least one electroactive compound,
the precipitation step of the electroactive compound, whereby a suspension is obtained,
a separation step of the suspension, whereby a solid residue and an effluent are obtained, and
optionally, a rinsing step with water of the solid residue obtained after the separation step, whereby a rinsed solid residue is obtained.

3. The method according to claim 1, wherein the precipitation step comprises the addition of an anti-solvent of the electroactive compound and/or the addition of an acid or base and/or the addition of a salt to the aqueous electrolyte.

4. The method according to claim 1, wherein the precipitation step comprises the addition of an acid to the aqueous electrolyte, or the addition of a base.

5. The method according to claim 1, wherein the precipitation step comprises the addition of a strong acid, the volume of added strong acid representing between 0.1% and 40% of the volume of the aqueous electrolyte to be processed, depending on the initial pH of the solution and composition thereof.

6. The method according to claim 1, wherein the precipitation step comprises the addition of a weak acid, the volume of added weak acid representing between 0.1% and 60% of the volume of the aqueous electrolyte to be processed.

7. The method according to claim 1, wherein the precipitation step comprises the addition of a base in the form of an aqueous solution of an alkaline hydroxide, the concentration of alkaline hydroxide being between 1 and 25 moles per litre, the volume of added base representing between 0.1% and 40% of the volume of the aqueous electrolyte to be processed.

8. The method according to claim 2, additionally comprising a formulation step of the solid residue, comprising dissolution of the solid residue in an aqueous medium to obtain a recycled electrolyte.

9. The method according to claim 1, wherein the electroactive compound is at least one form of a redox couple, the oxidized form of which is a compound of formula (F) 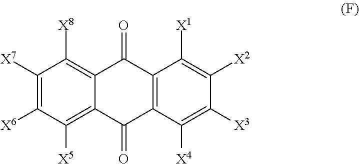
where X¹, X², X³, X⁴, X⁵, X⁶, X⁷ and X⁸ are each independently selected from the group consisting in a hydrogen atom, an OH group, COOH group, SO₃H group, -A-COOH group, —O-A-COOH group, -A-SO₃H group, —O-A-SO₃H group, and a saturated or unsaturated, linear, cyclic or branched hydrocarbon group having 1 to 10 carbon atoms,
A being a saturated or unsaturated, linear, cyclic or branched hydrocarbon group having 1 to 10 carbon atoms,
and/or a salt thereof.

10. The method according to claim 1, wherein the electroactive compound is at least one form of a redox couple, the oxidized form of which is a compound of formula: 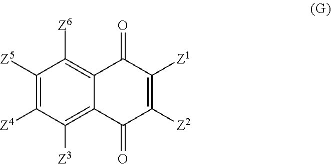
where Z¹, Z², Z³, Z⁴, Z⁵ and Z⁶ are each independently selected from the group consisting in a hydrogen atom, an OH group, COOH group, SO₃H group, -A-COOH group, —O-A-COOH group, -A-SO₃H group, —O-A-SO₃H group, and a saturated or unsaturated, linear, cyclic or branched hydrocarbon group having 1 to 10 carbon atoms,
A being a saturated or unsaturated, linear, cyclic or branched hydrocarbon group having 1 to 10 carbon atoms,
and/or a salt thereof, in particular a sodium or potassium salt.

11. The method according to claim 1, wherein the electroactive compound is at least one form of a redox couple, the oxidized form of which is a compound of formula (H): 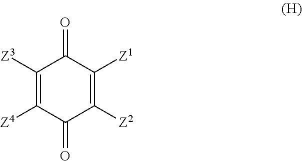
or a compound of formula: 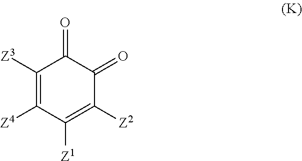
where Z¹, Z², Z³ and Z⁴ are each independently selected from the group consisting in a hydrogen atom, an OH group, COOH group, SO₃H group, -A-COOH group, —O-A-COOH group, -A-SO₃H group, —O-A-SO₃H group, and a saturated or unsaturated, linear, cyclic or branched hydrocarbon group having 1 to 10 carbon atoms,
A being a saturated or unsaturated, linear, cyclic or branched hydrocarbon group having 1 to 10 carbon atoms,
and/or a salt thereof, in particular a sodium or potassium salt.

12. The method according to claim 2, wherein the aqueous electrolyte is a negolyte, and the method additionally comprises a chemical oxidation step-between the collecting step and the precipitation step, comprising the contacting of the negolyte with an oxidant able to oxidize the reduced form of the redox couple.

13. The method according to claim 2, wherein the aqueous electrolyte is a posolyte, and the method additionally comprises a chemical reduction step between the collecting step and the precipitation step, comprising the contacting of the posolyte with a reductant able to reduce the oxidant of the redox couple.

14. The method according to claim 4, wherein the addition of the acid to the aqueous electrolyte is performed until a pH lower than or equal to 10 is obtained.

15. The method according to claim 4, wherein the addition of the base is performed until a pH higher than or equal to 7 is obtained.
